(19) United States
(12) Patent Application Publication
(10) Pub. No.: US 2008/0247802 A1
(43) Pub. Date: Oct. 9, 2008

(54) Starwheel

(76) Inventors: Phong X. Long, San Diego, CA (US); Fernando Juan Jover, San Diego, CA (US); Oreste Prada, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/732,892

(22) Filed: Apr. 4, 2007

(51) Int. Cl. B41J 11/00

(52) U.S. Cl. 400/629

(57) ABSTRACT

A starwheel for use in a printing device includes a plurality of rounded studs disposed around a periphery of the starwheel. A method of forming a starwheel that has a plurality of rounded studs disposed around a periphery of the starwheel includes injecting plastic into a mold to form the starwheel including the rounded studs.

### BACKGROUND

A typical printing system includes a print engine that uses electronic data to produce a desired hardcopy document corresponding to that data. The components of the print engine will vary depending on the type of printing system and the mechanism used to transform the electronic data into a printed image. In order to route the print media through a print zone where the print engine operates and to hold the print media in position during printing, the print media transport system often includes a number of starwheels.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 illustrates a generic printer with which the principles described herein may be practiced.

FIG. 2 illustrates a starwheel according to principles described herein

FIG. 3 illustrates a method of making starwheels according to principles described herein.

FIG. 4 illustrates a method of using starwheels according to principles described herein.

Throughout the drawings, identical reference numbers designate similar, but not necessarily identical, elements.

### DETAILED DESCRIPTION

The following specification describes a starwheel configuration for use in a print media transport system of a printing device. The starwheels described herein are configured to reduce the visible tracks that conventional starwheels sometimes leave on a print medium.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, the terms “printer” or “printing device” and similar terms will be used to refer broadly to any system that produces hardcopy documents and that uses a print media transport system to move pieces of a print medium during the printing process.

As used herein and in the appended claims, the term “print media transport system” will be used to refer to any mechanical system that moves pieces of a print medium through a printer. A print media transport system may include a picking system that pulls sheets of print medium from a supply area or tray and subsequent components that move the sheets of print medium through the printer, through a print zone including a print engine and to an output area or tray of the printer.

As used herein and in the appended claims, the term “print media transport path,” “transport path” or similar terms will be used to refer to the path through a printer along which a piece of print media travels from intake, through printing and to final output from the printer.

As used herein and in the appended claims, the term “starwheel” will be used to refer to a component of a print media transport system that includes elements spaced around its periphery or circumference that contact a piece of print media to help move that piece of print media through a print media transport path of a printer.

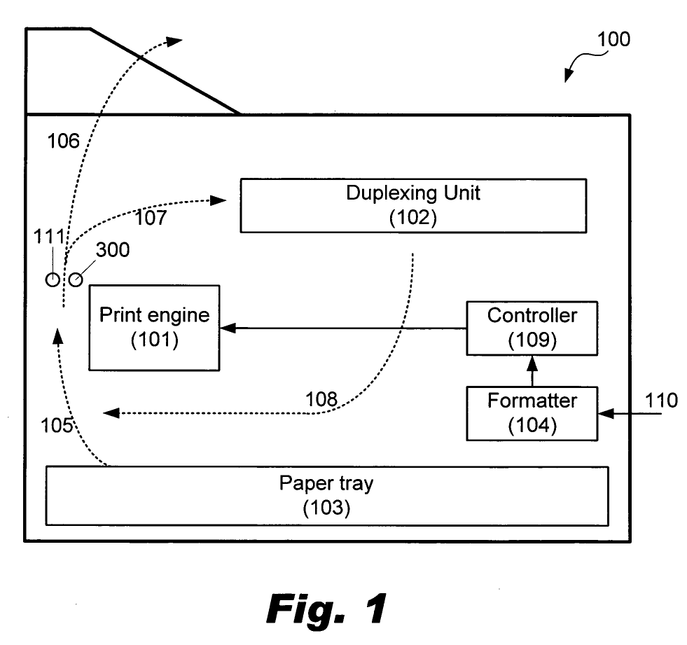

Turning now to the figures, FIG. 1 illustrates a generic printer and its hardware for performing basic and premium functions. In basic operation, the printer (100) receives print job data over a connection (110) with a host computer or computer network (not shown).

The print job data is received by a formatter (104). The formatter (104), which typically incorporates a microprocessor, related programmable memory and a page buffer, analyzes the incoming print job data. The formatter (104) formulates and stores an electronic representation of each page that is to be printed. Once a page has been formatted, it is transmitted to the page buffer within the formatter (104). From the page buffer, the electronic data is fed systematically to the print controller (109).

The print controller (109) drives a print engine (101). As noted above, the print engine (101) can be of various types depending on the type of printer (100). For example, the print engine may include a laser for a laser printer, an inkjet print head for an inkjet printer, etc. The print engine (101), under the control of the print controller (109) prints the data to a print medium, such as paper.

A print media transport system (105-108) moves the print medium through the printer (100). A picking portion (105) of the print media transport system will typically pull the paper or other print medium from a supply tray (103) and then route the print medium to the print engine (101) where printing occurs. An output portion (106) of the print media transport system may then transport the print medium out of the printer (100) for collection by the printer user. This is the scenario for one-sided or simplex printing.

Some printers provide the ability to print on both sides of the paper or other print medium. This is referred to as duplex printing. Where this is the case, the print medium, after having been printed on one side by the print engine (101) is received by a duplex portion (107) of the print medium transport path and routed to a duplexing unit (102) rather than being discharged from the printer (100).

The duplexing unit (102), which may also be considered part of the print media transport system, turns and reorients the paper so that the second side of the paper can be printed. The paper leaves the duplexing unit (102) and is transported (108) back to the print engine (101) where the second side of the paper is printed. Then the paper is transported (106) out of the printer (100) for collection by the user.

As described above, the output portion (106) of the print media transport system may include a number of starwheels (e.g. 300). These starwheels contact a leading edge of the print medium as it leaves the print engine (101), hold the print medium in place during printing and then help transport the printed document out of the printer (100) or to a duplexing unit (102). Typically, the starwheels (300) supply a downward pressure on the print medium so that rubber output rollers (e.g., 111) beneath the starwheels (300) have enough traction to move the print medium. A printer may comprise, for example, as many as 24 starwheels.

However, traditional metal starwheels with relatively sharp points have a tendency to poke holes in the ink layer on the print medium. Moreover, as the starwheels contact the print medium, the starwheels may pick up the newly deposited ink and then redeposit the ink on the print medium elsewhere. This can cause a visible track to occur on the print medium where the starwheel rolled over the medium.

This visible track can become worse as printing speeds increase since the time between deposit of the ink on the print medium and the contact with the starwheels is reduced. Thus, the newly deposited ink layer may not have sufficient time to dry before being placed in contact with the points of the starwheel.

To minimize this, the points of current starwheels are designed to be sharp so that the contact surface with the print medium is minimized. This is thought to create as small a puncture in the ink layer as possible. However, given the circumstances, the resulting starwheels marks can still be easily noticeable.

In any current printing system that employs starwheels, every hardcopy produced includes starwheel marks. Even the highest quality printouts have some level of starwheel marking that can be seen under close inspection or that is obvious in the right lighting conditions.

In addition, the tips of the starwheels that contact the opposing output rollers and the surface materials of the starwheels and the drive rollers are made compatible to prevent excess wear of the tips of the starwheels and/or the surface of the output rollers. For example, the starwheels are often formed of stainless steel and the drive rollers are often formed of plastic or rubber. Forming the output rollers of plastic or rubber, however, may not facilitate the most accurate routing of the print medium during printing thereby leading to image quality defects.

Also, a bottom print margin of the print medium should be sufficient to ensure that the print medium is held in position on an entry side of the print zone by other rollers or wheels of the print media transport system other than the starwheels and the output rollers. Consequently, the size of the bottom print margin, which is defined as the distance between rollers on the entry side of the print zone and the print zone itself, limits how close printing can occur to the bottom of the page. Such a limit affects, for example, duplex printing where a bottom print margin on a second side of the print media dictates the actual top print margin for that first side of the print media. This may prevent equal top and bottom print margins for both sides of the print medium.

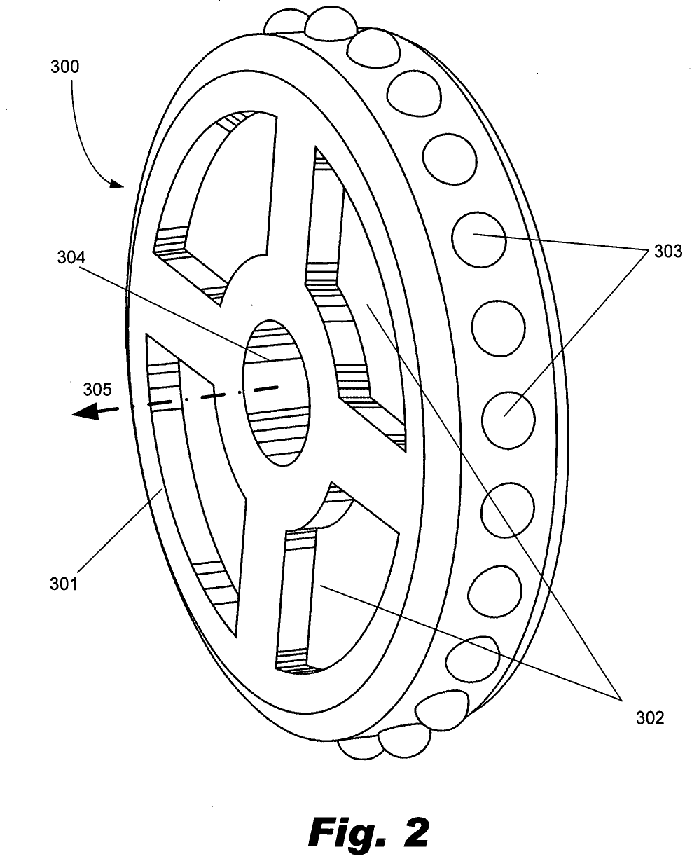

FIG. 2 illustrates a starwheel according to principles described herein. As shown in FIG. 2, the starwheel (300) is formed entirely of plastic. For example, a mixed plastic including polytetrafluoroethylene (Teflon®) and any of polyoxymethylene (POM), acetal resin, polytrioxane or polyformaldehyde (e.g., Delrin® by DuPont). Consequently, the starwheel (300) can be molded as a single body (301), for example, by injection molding. This makes the starwheel (300) much easier and more economical to produce.

The body (301) of the starwheel (300) may have a diameter of about 7.45 mm with a thickness of 1.77 mm. The body (301) also includes a central opening (304) that may be, in some embodiments, 1.5 mm in diameter. The central opening (304) is used to mount the starwheel (300) on a drive shaft or axle (not shown) in a printer or printing device. The starwheel (300) can then be driven against an output or other roller to transport sheets of print media as described above.

In some embodiments, the body (301) of the starwheel (300) may include a number of depressions (302) arranged radially around the rotational axis (305) or central opening (304) of the wheel (300). These depressions minimize the weight of the starwheel (300) and its rotational inertia.

Rather than the sharp points of previous starwheels, the starwheel (300) of FIG. 2 has a number of rounded studs (303) disposed around the circumference or periphery of the wheel (300). These studs (303) may be hemi-spherically shaped, although other shapes are possible. In some examples, the studs (303) may be formed of the same plastic as the rest of the unit (300).

In some embodiments, the studs (303) are 3 mm in diameter. Additionally, in some embodiments, the studs (303) are spaced at 15° intervals around the full 3600 of the starwheel (300). With the studs (303), the overall diameter of the wheel (300) in this example is about 8 mm.

The overall dimensions of the starwheel (300) can be identical to those of previous starwheels. Consequently, the starwheel (300) of FIG. 2 can be used as a direct replacement for the previous starwheel of FIG. 2 with no modifications to either the starwheel or the printer or printing system in which it is installed.

As will be appreciated by those skilled in the art, the studs (303) of the starwheel (300) will be able to create traction between a sheet of print medium and an underlying output roller so that the print medium can be transported without puncturing or disturbing the ink layer printed on the print medium. The geometry of the hemispheric studs (303) allows them to sit on the printed ink layer of a printed page while making a minimal physical impact. The studs (303) do not puncture the ink layer and, with lower friction plastics, even minimize rubbing of the ink layer. Additionally, the configuration and plastic construction material of the starwheel (300) may allow the cooperating output roller to be formed of different materials able to provide a better print media transport function.

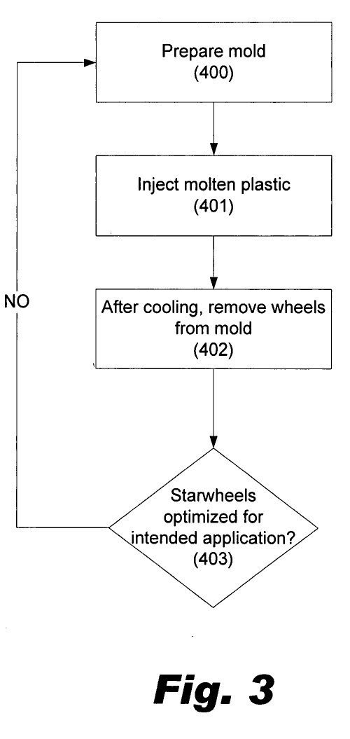

FIG. 3 illustrates a method of making starwheels according to principles described herein. As shown in FIG. 3, a mold is first prepared (step 400) according to the desired shape, size and configuration of the starwheels being produced. Due to the relatively small size of the starwheels, a single mold may include tens or even hundreds of cavities each capable of producing an all-plastic starwheel.

Next, molten plastic is injected (step 401) into the mold. As noted above, a mixed plastic may be used. In some embodiments, the mixture will include polytetrafluoroethylene (Teflon®) and any of polyoxymethylene (POM), acetal resin, polytrioxane or polyformaldehyde (e.g., Delrin® by DuPont).

After the plastic is allowed to cool in the mold, the newly-formed starwheels are removed (step 402) from the mold. Further processing may then be employed, in some embodiments, to produce a desired surface finish on the starwheels.

Because the production process for these starwheels is so relatively simple and inexpensive, the wheels can be optimized for any given application. If one run of starwheels does not prove optimal for an intended application (determination 403), the mold can be adjusted and the process of FIG. 3 repeated until the desired result is achieved.

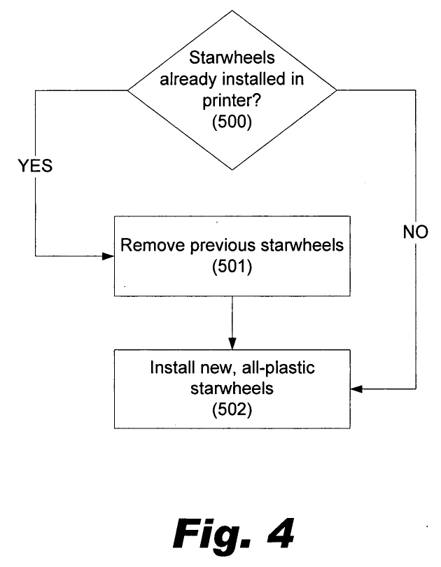

FIG. 4 illustrates a method of using starwheels according to principles described herein. As shown in FIG. 4 and as mentioned above, the starwheels described herein can be formed with essentially the same overall dimensions as previous starwheels. Consequently, the starwheels described herein can be used as a direct replacement for previous starwheels.

As shown in FIG. 4, if a printer or printing system already has starwheels installed (determination 500), those starwheels can be removed (step 501). Then, new, all-plastic starwheels, as described herein, can be installed (step 502). Alternatively, the all-plastic starwheels described herein can be installed as original equipment (step 502) in a new printer or printing device.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A starwheel for use in a printing device, said starwheel comprising:
a plurality of rounded studs disposed around a periphery of said starwheel.

2. The starwheel of claim 1, wherein said studs are made of plastic.

3. The starwheel of claim 2, wherein said plastic comprises a mixture of any of polytetrafluoroethylene, polyoxymethylene (POM), acetal resin, polytrioxane or polyformaldehyde.

4. The starwheel of claim 1, wherein said rounded studs are hemispherically shaped.

5. The starwheel of claim 1, further comprising recesses formed in a body of said starwheel.

6. The starwheel of claim 1, wherein said studs are spaced at 15° around said periphery of said starwheel.

7. The starwheel of claim 1, wherein a body of said starwheel and said rounded studs are integrally formed as a single piece from a common material.

8. A printing device having a print media transport path, said print media transport path comprising:
an output roller; and
a starwheel cooperating with said output roller, said starwheel comprising a plurality of rounded studs disposed around a periphery of said starwheel.

9. The printing device of claim 8, wherein said studs are made of plastic.

10. The printing device of claim 9, wherein said plastic comprises a mixture of any of polytetrafluoroethylene, polyoxymethylene (POM), acetal resin, polytrioxane or polyformaldehyde.

11. The printing device of claim 8, wherein said rounded studs are hemispherically shaped.

12. The printing device of claim 8, further comprising recesses formed in a body of said starwheel around a central opening.

13. The printing device of claim 8, wherein said studs are spaced at 15° around said periphery of said starwheel.

14. The printing device of claim 8, wherein a round body of said starwheel and said rounded studs are integrally formed as a single piece from a common material.

15. A method of forming a starwheel comprising a plurality of rounded studs disposed around a periphery of said starwheel, said method comprising injecting plastic into a mold to form said starwheel including said rounded studs.

16. The method of claim 15, further comprising, with said mold, forming recesses in a body of said starwheel around a central opening.

17. The method of claim 15, further comprising, with said mold, forming said studs with a hemispherical shape.

18. The method of claim 15, further comprising, with said mold, spacing said studs at 15° around said periphery of said starwheel.

19. The method of claim 15, wherein said plastic comprises a mixture of any of polytetrafluoroethylene, polyoxymethylene (POM), acetal resin, polytrioxane or polyformaldehyde.

20. The method of claim 15, further comprising simultaneously forming a number of starwheels in separate recesses of said mold.
